(19) United States
(12) Patent Application Publication
(10) Pub. No.: US 2006/0259335 A1
(43) Pub. Date: Nov. 16, 2006

(54) Travel product inventory and rate management system and method

(76) Inventors: William E. La Macchia, Saukville, WI (US); John G. Ische, Cedarburg, WI (US)

Correspondence Address: GODFREY & KAHN S.C., 780 NORTH WATER STREET, MILWAUKEE, WI, 53202, US

(21) Appl. No.: 09/752,139

(22) Filed: Dec. 29, 2000

(51) Int. Cl. G06F 17/60

(52) U.S. Cl. 705/6; 705/26

(57) ABSTRACT

A travel product inventory and rate management system includes a bulk inventory and rate database containing inventory and rate information related to individual travel products provided by a number of travel product suppliers The system can include a component bundler that selectively chooses at least two of the plurality of individual travel products and combines them into a vacation package. The system has a connection to a vacation package seller allowing the vacation package seller to select and reserve the vacation package. The component bundler may be a dynamic component bundler that chooses the individual travel components and combines them into a vacation package at the time when the vacation package seller selects and reserves the vacation package or may choose the individual travel components and combine them into a vacation package prior to the time when the vacation package seller selects and reserves the vacation package. The travel product inventory and rate management system may also include a content services module, a customer services module, an accounting services module, and/or a marketing data management module. Each of the modules is integrated into the system so as to provide services to the vacation package seller and the travel product suppliers.

### FIELD OF THE INVENTION

This invention relates generally to the management of inventory and rates of vacation packages and the bundling, distributing and selling vacation packages, and more particularly to a system and method of managing inventory and rates of vacation packages and bundling, distributing and selling vacation packages using a computerized inventory and rate management system.

### BACKGROUND OF THE INVENTION

Vacation packages have been increasing in popularity in recent years because of, among other things, the convenience of one-stop shopping. Such vacation packages may include airline tickets, hotel rooms, cruises, rental cars, excursions, and other related products. In grouping together individual travel products into a vacation package, the vacation package seller provides travel agents and consumers with the ability to go to one source for an entire vacation. Such vacation packages typically offer better pricing to the travel agent and the consumer than could be obtained if the travel agent separately obtained the individual components. The vacation package seller is able to offer better pricing because, among other things, it can take advantage of discounts that are not available to individual travel agents or consumers due to the larger volume of travel products sold by the vacation package seller.

Vacation packages are typically distributed to consumers through travel agencies. As illustrated in FIG. 1A, when a consumer 100 telephones a travel agent 102 as indicated by line 104 to make a reservation for a particular vacation package, e.g., a hotel room in Maui, a rental car, an airplane seat, and a snorkeling trip, the travel agent 102 uses its computer as indicated by line 106 to access information about available vacation packages through a Global Distribution System (“GDS”) 108. (Telephone connections are indicated in FIG. 1A by dashed lines and computer connections are indicated by solid lines.) Examples of GDSs include the SABRE®, WORLDSPAN®, APOLLO®, and AMADEUS® systems. The GDS 108 is linked to the database of vacation package seller 110 as indicated by line 112 which contains pricing, availability, scheduling, and other information. Should the consumer 100 wish to make a reservation, that reservation is completed by the travel agent 102 through the GDS 108 which then conveys the reservation information to the vacation package seller 110. It is then up to the travel agent 102 working in connection with the vacation package seller 110 to complete the billing, fulfillment, and other servicing of the transaction. Access charges may also be remitted to the GDS 108 for its part in making the reservation possible. As an alternative to using a GDS 108, the travel agent 102 may directly telephone the vacation package seller 110 as indicated by line 114 to inquire about rates, schedules, availability, and to ultimately make a reservation. An individual consumer 100 may also directly call a vacation package seller 110 as indicated by line 115. In some instances, a travel agent 102 may have the ability to directly contact a particular packaged vacation package seller 110 via computer as indicated by line 116.

The vacation package seller 110 combines individual travel products into a vacation package and markets those vacation packages to travel agents and consumers. As indicated by lines 118, the vacation package seller 110 combines products from suppliers of individual travel products such as airlines 120, hotels 122, rental car companies 124, and excursion companies 126 (such as a snorkeling cruise provider). Of course, within each category of individual travel product, there are many suppliers from which to choose. For example, in selecting the air component of a vacation package, the vacation package seller 110 may be able to select from five or more different airlines 120, Airline A, Airline B, Airline C, Airline D, or Airline E. Because vacation package sellers 110 use a number of different travel product providers in assembling their vacation packages, the process of managing the relationships with each of the travel product suppliers and of accounting for purchases becomes time-consuming, burdensome, and expensive for the vacation package seller 110. Further, in certain instances vacation package sellers 110 must access a GDS 108 as indicated by line 130 in order to provide certain components of the vacation package, most typically airfare. If a GDS 108 is used to secure an individual travel product, there are additional costs and inefficiencies involved in the bundling of the vacation package.

As shown in FIG. 1B, the existing method of compiling vacation packages is also burdensome on the supplier of individual travel products. For example, an airline 120 may have to link its inventory of available seats and its fare schedule to any number of vacation package sellers 110 as indicated by lines 128. This requires the airline 120 to have an interface to its inventory and fare system that can accommodate a wide variety of vacation package sellers 110. It also does not readily allow the airline 120 to effectively manage the distribution of its seats so as to maximize revenue and provide incentives to vacation package sellers 110 that are more important customers to the airline 120. Further, this system requires the airline 120 to have a complicated accounting system that is capable of managing the relationships with a number of vacation package sellers 110. While a GDS 108 may be used to sell individual travel products to multiple vacation package sellers 110, using a GDS 108 to distribute individual travel products is not a cost effective or efficient distribution method to reach the many vacation package sellers.

Travel product suppliers typically depend on an expansion of consumer base for growth in sales. Thus, it is highly desirable for travel product suppliers to facilitate access to products to both existing and new vacation package sellers. Traditional sales and marketing methods such as education of vacation package sellers and advertising are expensive, time consuming, and develop growth slowly. Additionally, it is time-consuming and expensive to generate marketing data when the travel product supplier has relationships with numerous vacation package sellers. Further, when the travel product supplier distributes its products through numerous vacation package sellers, it does not have control over the distribution of its products because its inventory is usually available on a first come first serve basis. On occasions, a travel product supplier may temporarily reserve portions of its inventory for a particular vacation package seller. In such cases, the travel product supplier may be faced with unsold inventory that is returned if not sold by the vacation package seller thereby leaving the travel product supplier with inventory it must sell at the last minute. There is also a desire on the part of travel product suppliers to have the ability to manage pricing and availability for particular vacation package sellers in order to reward those that make a high number of reservations. Such an objective cannot be effectively accomplished using conventional systems.

Accordingly, a need exists for a packaged travel products inventory and rate management system and method that allows vacation package sellers to more widely and effectively bundle and distribute their products, completes the transaction after the reservation has been made, provides vacation package sellers with support services once the reservation has been made, and facilitates distribution of individual travel products by travel product suppliers.

### SUMMARY OF THE INVENTION

The system and method of the present invention includes or employs a system comprising a computer or network of computers that, together with associated databases and program modules, form an efficient, user-friendly packaged travel product inventory and rate management system. Unlike conventional computerized travel systems such as a GDS, a preferred embodiment of the packaged travel product inventory and rate management system portion of the present invention not only accepts reservations, but also bundles vacation products, manages bundled vacation packages for vacation package sellers, completes bookings, facilitates shopping and comparing between travel products, facilitates payment by vacation packagers and to travel product suppliers, distributes commissions, allows simultaneous marketing of travel products by travel product supplier to numerous vacation package sellers, and provides vacation package sellers with pre and post travel service of their bookings. As alluded to above, included in the inventory and rate management system portion of the present invention are databases of information including packaged travel product inventory information, individual travel component inventory information, rate information, and a variety of other information. The travel product inventory and rate management system portion of the present invention may be linked to the internet such that the system can be accessed by vacation package sellers and suppliers of individual travel products throughout the world.

As mentioned above, the system and method of the present invention includes an inventory and rate management system. A preferred embodiment of the inventory and rate management system includes a number of discrete components—databases of bulk travel product inventory and rates, a component bundler, a content services module, a customer services module, a marketing data module, and an accounting services module. Each of these components works with the others to effectively manage the sale and distribution of travel products in combined vacation packages by vacation package sellers. These components also provide travel product suppliers with the ability to effectively manage inventory and pricing and to obtain valuable market data.

One embodiment of the bulk inventory and rate database portion of the system includes databases of available individual travel components. The individual travel components are loaded into the databases by the suppliers and may contain restrictions or rules on their distribution. The database also contains information about the rates at which the travel product supplier is willing to sell the travel product and other restrictions such as time and date of flights may also be included in the pricing database. By using the system and method of the present invention, travel product suppliers thus gain the ability to manage inventory and pricing for numerous vacation package sellers using a single system.

The component bundler portion of the inventory and rate management system may be a dynamic bundling system that allows vacation package sellers to customize vacation packages for individual consumers as those consumers inquire about vacation packages. The use of the dynamic bundler enables the vacation package seller to tailor the vacation package to the needs of a particular consumer. A bundler that pre-selects and bundles travel products into vacation packages may also be used.

The inventory and rate management system may include a content services module. The content services module includes an interface to databases of information provided by individual travel product suppliers relating to the individual travel products. The databases allow vacation package sellers to provide information about travel options such as particulars about travel destinations such as hotels, rental cars, airlines, ships, and activities at the destination. Information for the database is provided by travel product suppliers and allows the travel product suppliers to effectively distribute information about travel products to a number of vacation package sellers without having to provide the information individually to each vacation package seller.

The inventory and rate management system may also include a customer service module. The customer services module can provide the vacation package seller with fulfillment services such as ticketing and billing, booking support to enable the reservation of individual travel products, and post-booking support for changes to reservations for individual travel products.

A marketing data management module may be included in the inventory and rate management system. The marketing data management module collects, stores, and allows access to a number of pieces of marketing data.

Additionally, the inventory and rate management system may include an accounting services module. The accounting service module facilitates the accounting function of transactions for the vacation package seller and the suppliers of individual travel products. Using the accounting system, the vacation package seller need only pay one entity for all the travel products it uses. Similarly, travel product suppliers need only look to one entity for payment of fees for all the inventory of travel products it sells to vacation package sellers.

Vacation package sellers gain an advantage by using the system and method of the present invention in that they can more easily compile vacation packages and account for sales and bookings. The packaged travel product distribution system and method of the invention also allows vacation package sellers to control distribution with lower costs than those associated with traditional methods by enabling them to look to one source for multiple travel products provided by numerous travel product suppliers. Additionally, the system and method of the present invention allows travel product suppliers to more effectively manage inventory and rates of travel products for inclusion in vacation packages by enabling them to look to one outlet for supplying numerous vacation package sellers. The system also allows joint marketing efforts to be made by the vacation package seller and the supplier of individual components.

Thus, the system and method of the present invention benefits vacation package sellers by providing a system and method where the vacation package seller can access a wide range of individual travel products from many travel product suppliers, where the vacation package seller does not have to develop the infrastructure and inventory to provide a variety of packaged travel products to their customers, and where the packaged travel product provider gains access to new travel products for inclusion in vacation packages. The system and method of the present invention also provides suppliers of individual travel products with a low cost, easy to implement system for providing travel products to numerous vacation package sellers. These and other objects and advantages of the present invention will become apparent from the detailed description, claims, and accompanying drawings.

### BRIEF DESCRIPTION OF THE DRAWINGS

FIG. 1A is a schematic diagram of the conventional system and method of compiling and distributing packaged travel products;

FIG. 1B is a schematic diagram of the conventional system and method used by suppliers of individual travel products to distribute individual travel products to vacation package sellers;

FIG. 2 is a schematic diagram of one embodiment of the system and method in accordance with the present invention;

FIG. 3 is a schematic diagram of one embodiment of the inventory and rate management system portion of the system and method of the present invention;

FIG. 4 is a schematic diagram of the bulk inventory and rate databases used in one embodiment of the inventory and rate management system portion of the system and method of the present invention;

FIG. 5 is a schematic diagram of the customer services module used in one embodiment of the inventory and rate management system portion of the system and method of the present invention;

FIG. 6 is a schematic diagram of the accounting services module used in one embodiment of the inventory and rate management system portion of the system and method of the present invention;

FIG. 7 is a schematic diagram of the content services module used in one embodiment of the inventory and rate management system portion of the system and method of the present invention; and

FIG. 8 is a schematic diagram of the marketing data management module used in one embodiment of the inventory and rate management system portion of the system and method of the present invention

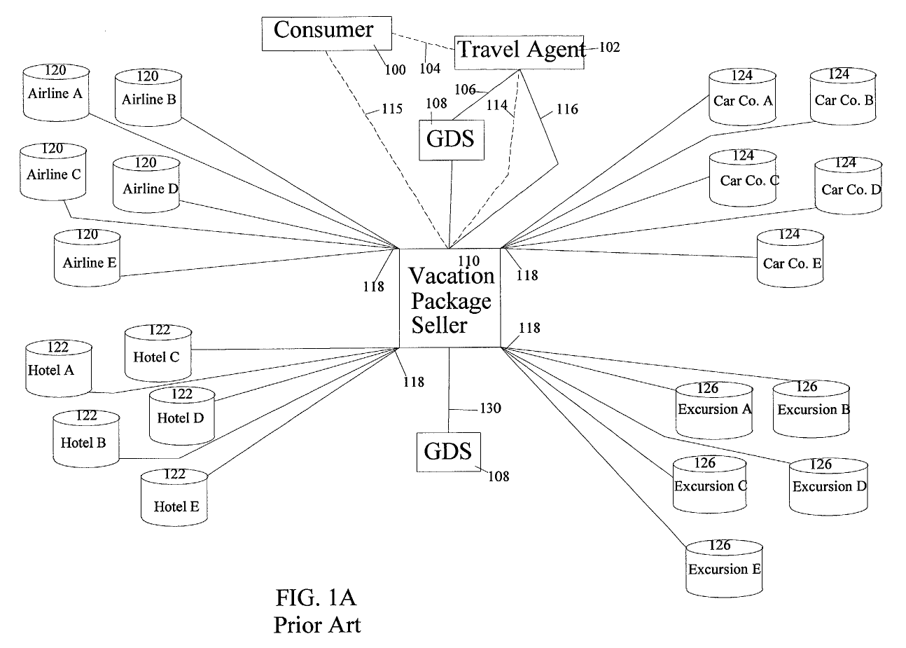

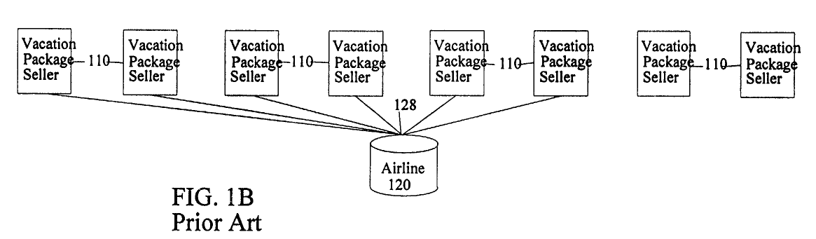

### DETAILED DESCRIPTION

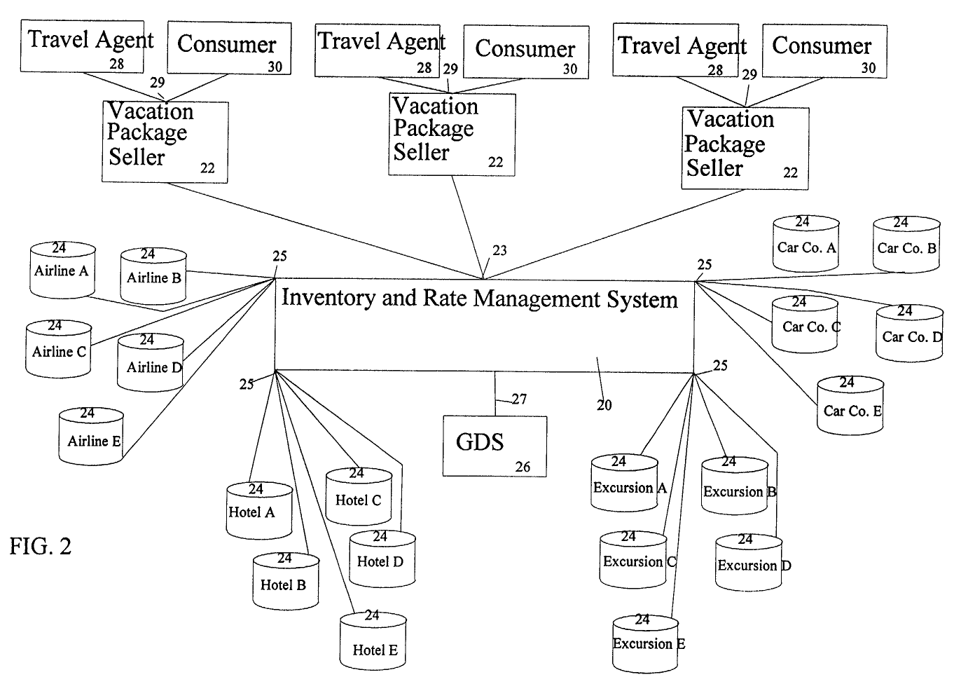

Illustrated generally in FIG. 2, a preferred embodiment of the inventory and rate management system 20 used in connection with the present invention not only accepts reservations, but also bundles vacation products, manages bundled vacation packages for the vacation package seller 22, completes bookings, facilitates shopping and comparing between travel products, facilitates payment by vacation package sellers 22 and to travel product suppliers 24, distributes commissions, allows simultaneous marketing of travel products by travel product providers 24 to numerous vacation package sellers 22, and provides vacation package sellers 22 with pre and post travel service of their bookings. As indicated by lines 25, the inventory and rate management system 20 is linked to the inventory systems of one or more travel product suppliers 24 and may, if necessary, be linked to one or more GDS 26 as indicated by line 27 in order to supply particular components of travel products such as air travel tickets. The inventory and rate management system 20 is linked to vacation package sellers 22 as indicated by lines 23 in order to allow vacation package sellers 22 to access the system to take advantage of its resources. The vacation package sellers 22 are linked to travel agents 28 and consumers 30 as indicated by lines 29 to allow the vacation package sellers 22 to distribute packaged vacations to the travel agents 28 and consumers 30. This connection 29 may be by computer line, telephone, or otherwise. The inventory and rate management system 20 may also be linked to the internet such that the system can be accessed by vacation package sellers 22 and suppliers of individual travel products 24 throughout the world using one or more interfaces.

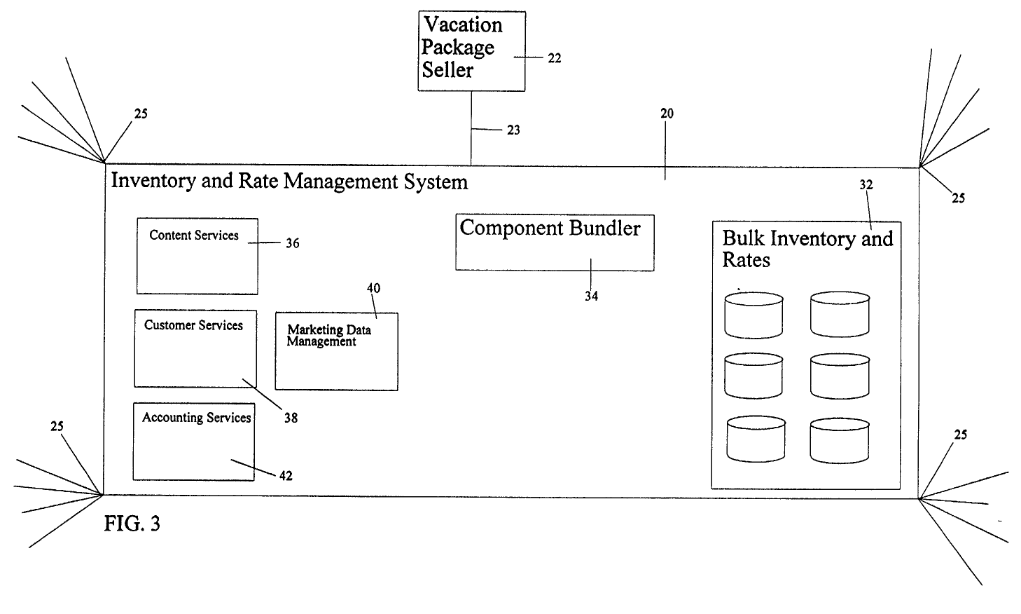

As shown in FIG. 3, one embodiment of the inventory and rate management system 20 includes a number of discrete components—databases of bulk travel product inventory and rates 32, a component bundler 34, a content services module 36, a customer services module 38, a marketing data module 40, and/or an accounting services module 42. Each of these components is integrated with the others to effectively manage the sale and distribution of travel products in combined vacation packages by vacation package sellers 22. These components also provide travel product suppliers 24 (not shown in FIG. 3, see FIG. 2) with the ability to effectively manage inventory and pricing and to obtain valuable market data. The inventory and rate management system 20 may be linked to the inventory database systems of travel product suppliers 24 as indicated by lines 25 by direct computer connection, via the internet, or via some other connection method such that the travel product supplier's 24 inventory can be accessed by the inventory and rate management system 20 and/or individual components thereof.

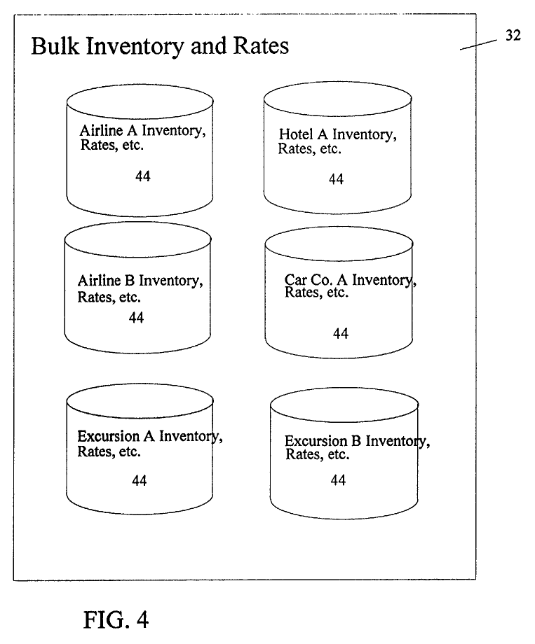

As shown in more detail in FIG. 4, included in the inventory and rate management system 20 within the bulk inventory and rates portion 32 are databases 44 of information including travel product inventory information, rate information, and a variety of other information such as restrictions or rules relating to the sale and distribution of the individual travel products. For example, Airline A may allocate from its database 44 of inventory in the inventory and rate management system 20 twenty-five seats on a flight from Milwaukee to Las Vegas for inclusion into vacation packages sold by a particular vacation package seller 22. Alternatively, Airline A may allow any vacation package seller 22 to access the database 44 and sell one or more of the twenty-five allocated seats as part of a vacation package. Postings of inventories of available travel products to these databases 44 may be made by the travel product suppliers 24 or by the operator of the inventory and rate management system 20. The database 44 may also contain rules about the rates at which the Airline A is willing to sell its inventory in the database 44 to particular vacation package sellers 22. For example, Airline A may sell its Milwaukee to Las Vegas seats for $150 to one vacation package seller 22 but may charge $175 for another vacation package seller 22. Of course, other restrictions such as time and date of flights may also be included in the database 44. By using the system and method of the present invention, travel product suppliers 24 thus gain the ability to manage inventory and pricing for numerous vacation package sellers 22 using a single system.

The component bundler 34 of the inventory and rate management system 20 may be a dynamic bundling system that allows vacation package sellers 22 to customize vacation packages for individual consumers as those consumers inquire about vacation packages. For example, if a consumer wants a trip to Maui provided by a particular vacation package seller 22, the vacation package seller 22 can access the component bundler 34 of the inventory and rate management system 20 to select from a number of available individual travel components to offer a complete vacation package. The package may include airfare, a hotel room, a rental car, and a luau on the night of arrival. Various options for each of these individual components may be provided to the consumer for selection. If a particular component is not included in the inventory databases 44 within the bulk inventory and rates portion 32 of the inventory and rate management system 20, the component bundler 34 can directly access the databases of the travel product supplier 24 to obtain the component. Further, for components supplied by travel product suppliers 24 with which the operator of the inventory and rate management system 20 has no relationship, the component bundler 34 may access a GDS 26 in order to obtain the particular component. The use of the dynamic bundler enables the vacation package seller 22 to tailor the vacation package to the needs of a particular consumer.

A component bundler 34 that pre-selects and bundles travel products into vacation packages may also be used either instead of or in conjunction with a dynamic bundler. Such a component bundler 34 pre-selects travel products from the bulk inventory and rate portion 32 of the inventory and rate management system 20 and presents the vacation package to vacation package sellers 22 as a single unit. The vacation package seller 22 can then sell the package through its usual channels to travel agents 28 or consumers 30. In cases where a particular travel product supplier 24 has special pricing on particular portions of its inventory, the use of a component bundler 34 that pre-selects components may be advantageous in allowing the vacation package seller 22 to present low price special vacation packages.

The inventory and rate management system 20 may include a content services module 36. As shown in FIG. 7, the content services module 36 includes one or more databases of information 46 provided by individual travel product suppliers 24 relating to the individual travel products. The databases 46 allow vacation package sellers 22 to provide information about travel options such as particulars about hotels, rental cars, airlines, ships, and activities at the destination. Information for the database 46 is provided by travel product providers 24 and allows the travel product providers 24 to effectively distribute information about travel products to a number of vacation package sellers 22 without having to provide the information individually to each vacation package seller 22. The travel product providers 24 can manipulate, edit, and update the information in the databases 46 using an interface to the inventory and rate management system 20. Further, using a content management and distribution feature 48, the content services module 36 may include the ability to tailor the content being provided to particular vacation package sellers 22 in order to best present the information in a manner that increases sales opportunities. Such tailoring of the content management and distribution feature 48 may be accomplished at the direction of the travel product supplier 24 or may be performed by the operator of the inventory and rate management system 20. In either case, the information in the databases 46 that is provided to particular vacation package sellers 22 may be controlled using the content management and distribution feature 48 of the content services component 36. Additionally, third party content such as reviews of destinations or particular travel products can be included in the content services module 36 and managed by a travel product provider 24 or the operator of the inventory and rate management system 20.

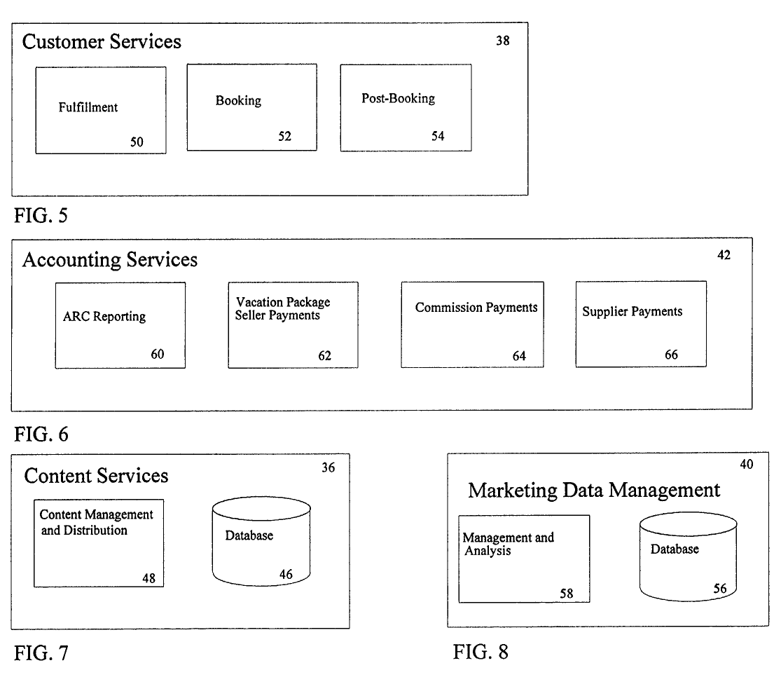

As shown in FIG. 3 and in more detail in FIG. 5, the inventory and rate management system 20 may also include a customer services module 38. The customer services module 38 can provide the vacation package seller 22 with fulfillment services 50 such as ticketing and billing, booking support 52 to enable the reservation of individual travel products, and post-booking support 54 for changes to reservations for individual travel products.

As shown in detail in FIG. 8 and generally in FIG. 3, a marketing data management module 40 may be included in the inventory and rate management system 20. The marketing data management module 40 collects and stores data in a database 56, and allows access to a number of pieces of marketing data through a data management and analysis component 58. For example, the marketing data management module 40 can collect data in its databases 56 for a particular travel product supplier 22 that allows the travel product supplier 22, using the marketing management and analysis component 58, to analyze which methods of pricing and inventory availability allocation result in the maximization of sales or profits. This data cannot be effectively or efficiently collected or analyzed when the travel product supplier 24 sells its products through relationships with many vacation package sellers 22 because the process of collecting the data is time-consuming and cost-prohibitive. Similarly, the marketing data management module 40 can collect data for a vacation package seller 24 in its databases 56 in order to use the marketing data management and analysis module 58 to assess which travel product suppliers 24 allow it to more cost effectively sell vacation packages. Such data is difficult if not impossible to compile and assess where the vacation package seller 22 has relationships with numerous travel product suppliers 24 because the collection of such data is time-consuming and expensive.

Additionally, the inventory and rate management system 20 may include an accounting services module 42 shown generally in FIG. 3 and in more detail in FIG. 6. The accounting service module 42 facilitates the accounting function of transactions for the vacation package sellers 22 and the travel product suppliers 24. The accounting module 42 may allow reporting of airline reservations through the Airline Reporting Corporation (“ARC”)—the entity that allows travel agents 28 and vacation package sellers 22 to issue airline tickets. The accounting module 42 may include information in a vacation package seller payment module 62 about the payments to be made by vacation package sellers 22 for the travel components they reserve. Through a supplier payments module 66, payments for purchased travel products to travel product suppliers 24 can be made. Using a commission payments module 64, the accounting services feature 42 may facilitate the distribution of commissions for the vacation package seller 22 to travel agents 28 and for the travel product providers 24 to vacation package sellers 22. The accounting services system 42 can provide reports to vacation package sellers 22 and travel product suppliers 24 regarding particular transactions or summaries of all transactions to ensure proper payment for purchased products. If desired, the operator of the inventory and rate management system 20 can allow the vacation package sellers 22 and travel product suppliers 24 to access the accounting system 42 to directly acquire information about transactions and to complete payments for transactions. Using the accounting system, the vacation package seller 22 need only pay one entity for all the travel products it uses. Similarly, travel product providers 24 need only look to one entity for payment of fees for all the inventory of travel products it sells to vacation package sellers 22.

For many smaller travel product providers 24, such as an individual hotel that is not part of a chain or network, it is very difficult and expensive to maintain relationships with many vacation package sellers 22. Thus, the smaller travel product providers 24 do not have the ability to reach a very large market of vacation package sellers 22 (and their travel agent 28 or individual consumer 22 customers) for the inclusion of travel products into vacation packages. For these travel product suppliers 24, use of the system and method of the present invention is particularly advantageous as the small travel product suppliers 24 can provide its products to numerous vacation package sellers 22 by establishing a relationship with the operator of the system and method of the present invention. Similarly, smaller vacation package sellers 22 may not have the ability to effectively maintain relationships with numerous travel product providers 24. By establishing a relationship with the operator of the system and method of the present invention, the smaller vacation package seller 22 can obtain travel products from many travel product suppliers 23 from which it could not otherwise obtain travel products. The system and method of the present invention thereby allows new entities, including travel product suppliers 24 themselves, to become vacation package sellers 22 without having to first overcome the significant obstacles to entry into the vacation package selling market. Such obstacles primarily involve the establishment of relationships with the numerous travel product providers 24 from which travel products must be purchased in order to compete effectively with established vacation package sellers 22.

Thus, the system and method of the present invention benefits vacation package sellers 22 by providing a system and method where the vacation package seller 22 can access a wide range of individual travel products from many travel product suppliers 24, where the vacation package seller 22 does not have to develop the infrastructure and inventory to provide a variety of packaged travel products to their customers, and where the vacation package seller 22 gains access to new travel products for inclusion in vacation packages. The system and method of the present invention also provides travel product suppliers 24 with a low cost, easy to implement system for providing travel products to numerous vacation package sellers 22.

As illustrated by the foregoing detailed description and shown in the Figures, the present invention is more suitable as a system and method of distributing packaged travel products than are conventional systems and methods. The present invention overcomes the limitations and disadvantages of existing systems in that it allows packaged vacation sellers to efficiently and economically sell packaged travel products, and allows travel product suppliers to take advantage of a inventory and rate management system to which they would not otherwise have the ability to access.

Although the invention has been herein shown and described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and therefore, the invention is to be taken as including all reasonable equivalents to the subject matter of the appended claims.

1. A travel product inventory and rate management system comprising:
a bulk inventory database containing inventory information, a rate database containing rate information, and a travel product information database containing travel product information, the information in each of the databases related to a plurality of individual travel products provided by a plurality of travel product suppliers and including rules provided by the travel product suppliers regarding availability and pricing for a plurality of vacation product sellers, the travel product inventory and rate management system applying said rules to allocate inventory and determine pricing for individual travel products when such products are selected by a particular one of the plurality of vacation product sellers;
an interface between the travel product inventory and rate management system and the particular one of the plurality of vacation product sellers such that the particular one of the plurality of vacation product sellers is provided with the ability to select and book an individual travel product or a vacation package combined by a component bundler after application of said rules for allocation of inventory and determination of pricing by the travel product inventory and rate management system.

2. (canceled)

3. (canceled)

4. (canceled)

5. (canceled)

6. (canceled)

7. (canceled)

8. (canceled)

9. A method of managing an inventory of travel products comprising the following steps:
providing bulk inventory, travel product information, and rate databases as part of an inventory and rate management system;
loading the bulk inventory, travel product information, and rate databases with inventory, travel product, and rate information for a plurality of individual travel products provided by a plurality of travel product suppliers, the information including rules provided by the plurality of travel product suppliers regarding availability and pricing for the plurality of individual travel products as related to individual ones of a plurality of vacation product sellers, the inventory and rate management system applying said rules to allocate inventory and determine pricing for each of the plurality of individual travel products when such products are selected by an individual one of the plurality of vacation product sellers; and
selecting at least one of plurality of individual travel products through an interface between an individual one of the plurality of vacation package sellers and the inventory and rate management system.

10. (canceled)

11. (canceled)

12. (canceled)

13. (canceled)

14. (canceled)

15. (canceled)

16. A method of distributing a vacation package to a plurality of vacation package sellers comprising the following steps:
providing an inventory and rate management system including a bulk, inventory, travel product information, and rate database, the bulk inventory, travel product information, and rate database containing inventory, travel product, and rate information related to a plurality of individual travel products supplied by a plurality of travel product suppliers, the information including rules provided by the plurality of travel product suppliers regarding availability and pricing for the plurality of individual travel products the inventory and rate management system applying said rules to allocate inventory and determine pricing for each of the plurality of individual travel products when such products are selected by a particular one of the plurality of vacation package sellers;
combining at least two of the plurality of individual travel products supplied by a plurality of travel product suppliers into the vacation package and applying the rules provided by the plurality of travel product suppliers regarding availability and pricing to determine availability and pricing for the vacation package for the particular one of the plurality of vacation package sellers;
selectively accessing the vacation package through an interface between the particular one of the plurality of vacation package sellers and the inventory and rate management system; and
reserving the vacation package through the interface to the inventory and rate management system.

17. (canceled)

18. The method of claim 16 wherein the step of compiling at least two of the plurality of individual travel products into a vacation package and applying the rules provided by the plurality of travel product suppliers regarding availability and pricing to determine availability and pricing for the vacation package for the particular one of the plurality of vacation package sellers is performed by a dynamic component bundler at the time when the particular one of the plurality of vacation package sellers accesses the vacation package through the interface.

19. The method of claim 16 wherein the step of compiling at least two of the plurality of individual travel products into a vacation package and applying the rules provided by the plurality of travel product suppliers regarding availability and pricing to determine availability and pricing for the vacation package for the particular one of the plurality of vacation package sellers is performed by a component bundler prior to the time when the particular one of the plurality of vacation package sellers accesses the vacation package through the interface.

20. (canceled)
